(19) United States
(12) Patent Application Publication
(10) Pub. No.: US 2010/0313791 A1
(43) Pub. Date: Dec. 16, 2010

(54) CALCIUM PHOSPHATE BONE CEMENT, PRECURSOR THEREOF AND FABRICATION METHOD THEREOF

(75) Inventors: Wen-Cheng CHEN, Tainan County (TW); Chun-Cheng HUNG, Kaohsiung (TW); Chia-Ling KO, Kaohsiung (TW)

Correspondence Address: PAI PATENT & TRADEMARK LAW FIRM, 1001 FOURTH AVENUE, SUITE 3200, SEATTLE, WA, 98154, US

(73) Assignee: KAOHSIUNG MEDICAL UNIVERSITY, Kaohsiung (TW)

(21) Appl. No.: 12/574,063

(22) Filed: Oct. 6, 2009

(30) Foreign Application Priority Data
Jun. 12, 2009 (TW) 098119682

(51) Int. Cl. C04B 12/02

(52) U.S. Cl. 106/690

(57) ABSTRACT

The invention provides a calcium phosphate bone cement, a precursor and a fabrication method thereof. The fabrication method comprises: (a) dissolving a calcium phosphate with a low Ca/P atomic ratio in an acid solution, wherein the Ca/P atomic ratio is less than 1.33; (b) adding a calcium phosphate compound into the acid solution to obtain a reaction solution; (c) allowing the reaction solution to stand to grow nanocrystallites on surfaces of the calcium phosphate with low Ca/P atomic ratio; (d) filtering and drying the solution of step (c) to obtain a calcium phosphate powder with low Ca/P atomic ratio having nanocrystallites on the surface; and (e) mixing the powder of step (d) and a calcium phosphate powder with a high Ca/P atomic ratio.

### CROSS REFERENCE TO RELATED APPLICATIONS

This Application claims priority of Taiwan Patent Application No. 098119682, filed on Jun. 12, 2009, the entirety of which is incorporated by reference herein.

### BACKGROUND OF THE INVENTION

1. Field of the Invention

The present invention relates to a bone cement, and in particular relates to a calcium phosphate bone cement (CPC).

2. Description of the Related Art

Calcium phosphate bone cements (CPC) have been used as a bone filling material due to excellent biocompatibility and osteoconductivity characteristics.

In 1983, Brown and Chow disclosed a powdered mixture obtained by mixing tetracalcium phosphate (TTCP) and a dicalcium phosphate anhydrous (DCPA) powder. After the mixed solution is placed into a diluted phosphate ion-containing solution, a hydroxyapatite (HA) product phase occurs. Related art for CPC may be found in U.S. Pat. Nos. 7,204,876, 7,186,294, 6,960,249, and 6,379,453.

Despite its use however, CPC has the following deficiencies when used clinically: (1) a long setting time; (2) low mechanical strength; (3) not easily absorbed by body fluids.

Thus, there is a need to develop a superior CPC, which may be applied clinically, mitigating the above deficiencies.

### BRIEF SUMMARY OF THE INVENTION

The invention provides a fabrication method for a calcium phosphate bone cement, comprising: (a) dissolving a calcium phosphate with a low Ca/P atomic ratio in an acid solution, wherein the Ca/P atomic ratio is less than 1.33; (b) adding a calcium phosphate compound or providing a calcium ion-containing compound and a phosphate ion-containing compound into the acid solution to obtain a reaction solution; (c) allowing the reaction solution to stand to grow nanocrystallites on surfaces of the calcium phosphate with a low Ca/P atomic ratio; (d) filtering and drying the solution of step (c) to obtain a calcium phosphate powder with a low Ca/P atomic ratio having nanocrystallites on its surface; and (e) mixing the powder of step (d) and a calcium phosphate powder with a high Ca/P atomic ratio.

The invention also provides a calcium phosphate bone cement precursor, comprising: a calcium phosphate powder with a low Ca/P atomic ratio having nanocrystallites on the surface thereof, wherein the low Ca/P atomic ratio is less than 1.33; and a calcium phosphate powder with a high Ca/P atomic ratio, wherein the high Ca/P atomic ratio is larger than 1.33.

The invention also provides a calcium phosphate bone cement, comprising: a calcium phosphate powder with a low Ca/P atomic ratio having nanocrystallites on the surface thereof; and a calcium phosphate powder with a high Ca/P atomic ratio, wherein the calcium phosphate powder with a high Ca/P atomic ratio is mixed with the calcium phosphate powder with a low Ca/P atomic ratio to form the calcium phosphate bone cement, and the calcium phosphate bone cement has a biphasic or multiphasic product phase.

A detailed description is given in the following embodiments with reference to the accompanying drawings.

### BRIEF DESCRIPTION OF THE DRAWING

For a more complete understanding of the present invention, and the advantages thereof, reference is now made to the following descriptions taken in conjunction with the accompanying drawings, in which:

FIG. 1 shows a selected area diffraction (SAD) of the CPC of the invention; and

FIG. 2A to FIG. 2B show the x-ray diffraction images (Rigaku D-max IIIV x-ray diffractometer, Tokyo, Japan) of CPC of the invention;

FIG. 3 shows a compressive strength of the CPC of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a fabrication method for a calcium phosphate bone cement. The fabrication method comprises the step (a) to (e). The method begins with step (a) in which a calcium phosphate with a low Ca/P atomic ratio is dissolved in an acid solution, wherein the low Ca/P atomic ratio is less than 1.33. For example, the calcium phosphate with the low Ca/P atomic ratio comprises dicalcium phosphate anhydrous (DCPA, CaHPO₄), dicalcium phosphate dihydrate (DCPD, CaHPO₄.2H₂O), monocalcium phosphate (MCPM, Ca(HPO₄)₂.H₂O), monocalcium phosphate anhydrate (MCPA, Ca(HPO₄)₂), calcium sodium phosphates (CaNaPO₄) or calcium potassium phosphate (CaKPO₄).

The above acid solution comprises HNO₃, HCl, H₃PO₄, H₂CO₃, NaH₂PO₄, KH₂PO₄, NH₄H₂PO₄, CH₃COOH, malic acid, lactic acid, citric acid, oxalic acid, malonic acid, succinic acid, glutaric acid, tartaric acid or combinations thereof. However, the acid solutions are not limited to the acid solutions disclosed herein, the aqueous solutions with a pH value less than 7, or preferably less than 5, are also included within the scope of the invention.

The above calcium phosphate with a low Ca/P atomic ratio is present in a concentration of about 0.01-10 g/ml. In one embodiment, the preferably concentration is about 0.125 g/ml.

The method continues with step (b) in which a calcium phosphate compound is added into the acid solution to obtain a reaction solution. The calcium phosphate compounds are used as an ion additive to provide sufficient calcium ions and phosphate ions for the sequential nanocrystallites growing reaction. The calcium phosphate compound comprises octacalcium phosphate (OCP, Ca₈(HPO₄)₂(PO₄)₄.5H₂O), tricalcium phosphate (TCP, Ca₃(PO₄)₂), amorphous calcium phosphate (ACP, Caₓ(PO₄)_{y}.nH₂O), calcium-deficient hydroxyapatite (CDHA, Ca₁₀(HPO₄)ₓ(PO₄)₆₋ₓ(OH)₂₋ₓ, 0<X<1), fluorapatite (FA, Ca₅(PO₄)₃F), hydroxyapatite (HA, Ca₁₀(PO₄)₆(OH)₂), tetracalcium phosphate (TTCP, Ca₄(PO₄)₂O), calcium potassium phosphate (CaKPO₄), calcium sodium phosphates (CaNaPO₄) or combinations thereof.

In addition to the calcium phosphate compound, a calcium ion-containing compound and a phosphate ion-containing compound are also used as the ion additives. For example, the calcium ion-containing compound comprises calcium oxide (CaO), calcium hydroxide (Ca(OH)₂) or calcium carbonate (CaCO₃). The phosphate ion-containing compound comprises phosphorus pentoxide (P₂O₅), sodium phosphate (Na₃PO₄), sodium phosphate dibasic (Na₂HPO₄), sodium dihydrogen phosphate (NaH₂PO₄), phosphoric acid (H₃PO₄), potassium phosphate (K₃PO₄), potassium phosphate dibasic (K₂HPO₄), sodium dihydrogen phosphate (KH₂PO₄), ammonium phosphate ((NH₄)₃PO₄), ammonium phosphate dibasic ((NH₄)₂HPO₄) or ammonium dihydrogen phosphate (NH₄H₂PO₄)

The method continues with step (c) in which the reaction solution is allowed to stand to grow nanocrystallites on surfaces of the calcium phosphate with a low Ca/P atomic ratio. The nanocrystallites are grown at room temperature for about 5-60 minutes, or preferably about 10-50 minutes, and further preferably about 20-30 minutes. The nanocrystallites have a width of about 1-100 nm and a length of about 10-1000 nm.

Note that because the calcium phosphate with a low Ca/P atomic ratio (Ca/P<1.33) is in an acid state which is unstable when in a basic body fluid (pH is about 7.4), a calcium phosphate bone cement made by it can't pass the cytotoxicity test. Therefore, the nanocrystallites on the surface of the calcium phosphate with a low Ca/P atomic ratio not only shorten the setting time but also prevent the calcium phosphate with a low Ca/P atomic ratio from dispersing in a simulate body fluid.

The method continues with step (d) in which the solution of the step (c) is filtered, dried and baked at a temperature of 50-100° C. in an oven to obtain a calcium phosphate powder with a low Ca/P atomic ratio having nanocrystallites on the surface.

The method continues with step (e) in which the powder of step (d) is mixed with a calcium phosphate powder with a high Ca/P atomic ratio, wherein the high Ca/P atomic ratio is greater than 1.33 (Ca/P≧1.33). The calcium phosphate powder with a high Ca/P atomic ratio comprises octacalcium phosphate (OCP, Ca₈(HPO₄)₂(PO₄)₄.5H₂O), tricalcium phosphate (TCP, Ca₃(PO₄)₂), amorphous calcium phosphate (ACP, Caₓ(PO₄)_{y}.nH₂O), calcium-deficient hydroxyapatite (CDHA, Ca₁₀(HPO₄)ₓ(PO₄)₆₋ₓ(OH)₂₋ₓ, 0<X<1), hydroxyapatite (HA, Ca₁₀(PO₄)₆(OH)₂)), fluorapatite (FA, Ca₅(PO₄)₃F) or tetracalcium phosphate (TTCP, Ca₄(PO₄)₂O). The powder of step (d) and the calcium phosphate powder with a high Ca/P atomic ratio are mixed with a ratio of 1/1-3/1, or preferably 1.5/1-2.5/1.

The calcium phosphate with a low Ca/P atomic ratio has a diameter less than about 200 μm, and larger than that of the calcium phosphate with a high Ca/P atomic ratio. In one embodiment, the calcium phosphate with a low Ca/P atomic ratio is about 8 μm, the calcium phosphate with a high Ca/P atomic ratio is about 3 μm. Note that in prior art, preferable diameter distribution of the calcium phosphate with a low atomic ratio Ca/P and the calcium phosphate with a high Ca/P atomic ratio is about 1 μm and 10 μm. However, the calcium phosphate bone cement of the invention shows that the preferably diameter distribution may be changed, and is not limited.

Note that the calcium phosphate with a low Ca/P atomic ratio is easily absorbed by the body fluid. However, excessive amounts thereof, may cause difficulties. For example, as the addition of the calcium phosphate with a low Ca/P atomic ratio increases, the mechanic strength of the calcium phosphate bone cement decreases and the cytotoxicity thereof increases. In order to maintain the mechanic strength at an acceptable level, the addition of the calcium phosphate with a low Ca/P atomic ratio is often less than that of the calcium phosphate with a high Ca/P atomic ratio. Therefore, compared with prior art, the mechanic strength of the calcium phosphate bone cement of the invention may be maintained at an acceptable level even though the amount of calcium phosphate with a low Ca/P atomic ratio is increased. Additionally, even though the amount of calcium phosphate with a low Ca/P atomic ratio is increased, the body fluid absorption rate of the calcium phosphate bone cement of the invention may be increased. Further, the calcium phosphate with a low Ca/P atomic ratio is stable in the basic environment (e.g. pH≧7) by the protection of the nanocrystallites. When the addition of the calcium phosphate with a low Ca/P atomic ratio is 1-fold to 3-fold of the calcium phosphate with a high Ca/P atomic ratio, the compressive strength of the calcium phosphate bone cement is larger than 30 MPa, which meets ASTM F451-99a standards.

Clinically, only basic calcium phosphate bone cement can exist in basic body fluid. Thus, in prior art, when a calcium phosphate bone cement is obtained by mixing calcium phosphate with a low Ca/P atomic ratio and the calcium phosphate with a high Ca/P atomic ratio, the final product phase of the calcium phosphate bone cement only has a single basic phase. For example, an apatite (HA) of a final product phase is obtained when dicalcium phosphate anhydrous (DCPA, CaHPO₄) and tetracalcium phosphate (TTCP, Ca₄(PO₄)₂O) are mixed. Compared with prior art, because the surface of the calcium phosphate with a low Ca/P atomic ratio is protected by the nanocrystallites, the original acid phase thereof can be preserved in basic body fluid. Therefore, the calcium phosphate bone cement of the invention may have a biphasic or multiphasic product phase, wherein the biphasic or multiphasic product phase comprises an acid phase and a basic phase.

The above acid phase comprises dicalcium phosphate anhydrous (DCPA, CaHPO₄), dicalcium phosphate dihydrate (DCPD, CaHPO₄.2H₂O), monocalcium phosphate (MCPM, Ca(HPO₄)₂.H₂O), monocalcium phosphate anhydrate (MCPA, Ca(HPO₄)₂), calcium sodium phosphates (CaNaPO₄) or calcium potassium phosphate (CaKPO₄). The basic phase comprises octacalcium phosphate (OCP, Ca₈(HPO₄)₂(PO₄)₄.5H₂O), tricalcium phosphate (TCP, Ca₃(PO₄)₂), amorphous calcium phosphate (ACP, Caₓ(PO₄)_{y}.nH₂O), calcium-deficient hydroxyapatite (CDHA, Ca₁₀(HPO₄)ₓ(PO₄)₆₋ₓ(OH)₂₋ₓ, 0<X<1), fluorapatite (FA, Ca₅(PO₄)₃F), hydroxyapatite (HA, Ca₁₀(PO₄)₆(OH)₂) or tetracalcium phosphate (TTCP, Ca₄(PO₄)₂O). In one embodiment, the biphasic product phase of the invention is dicalcium phosphate dihydrate (DCPD, CaHPO₄.2H₂O) and hydroxyapatite (HA, Ca₁₀(PO₄)₆(OH)₂). In another embodiment, multiphasic product phase of the invention is dicalcium phosphate dihydrate (DCPD, CaHPO₄.2H₂O), dicalcium phosphate anhydrous (DCPA, CaHPO₄) and hydroxyapatite (HA, Ca₁₀(PO₄)₆(OH)₂).

Thus, due to the biphasic or multiphasic product phase of the calcium phosphate bone cement of the invention, easy absorption by the body fluid is achieved versus the opposite for the calcium phosphate bone cement with a single basic phase, such as an apatite (HA), of prior art. Additionally, it is well known that the acid product phase is more easily absorbed by the body fluid than the basic product phase. Therefore, according to the implant position in clinical trials, those skilled in the art may adjust the ratio of the acid and basic product phase of the invention to improve the osteo-regeneration and biosorption rate.

The invention also provides a calcium phosphate bone cement precursor which comprises a calcium phosphate powder with a low Ca/P atomic ratio having nanocrystallites on the surface thereof, wherein the low Ca/P atomic ratio is less than 1.33 and a calcium phosphate powder with a high Ca/P atomic ratio, wherein the high Ca/P atomic ratio is greater than 1.33. The calcium phosphate powder with a low Ca/P atomic ratio having nanocrystallites on the surface is fabricated by the above steps (a) to (d). The nanocrystallites have a width of about 1-100 nm and a length of about 10-1000 nm. The nanocrystallites not only prevent the calcium phosphate powder with a low Ca/P atomic ratio from dispersing in simulate body fluid but also preserve the original acid phase of the calcium phosphate powder with a low Ca/P atomic ratio.

The calcium phosphate powder with a low Ca/P atomic ratio having nanocrystallites on the surface and the calcium phosphate powder with a high Ca/P atomic ratio are mixed with a ratio of 1/1˜3/1, or preferably 1.5/1-2.5/1.

The invention also provides a calcium phosphate bone cement which comprises a calcium phosphate powder with a low Ca/P atomic ratio having nanocrystallites on the surface and a calcium phosphate powder with a high Ca/P atomic ratio. The calcium phosphate bone cement has a biphasic or multiphasic product phase, wherein the biphasic or multiphasic product phase comprises an acid phase and a basic phase.

In one embodiment, the biphasic product phase of the invention is dicalcium phosphate dihydrate (DCPD, CaHPO₄.2H₂O) and hydroxyapatite (HA, Ca₁₀(PO₄)₆(OH)₂). Due to the biphasic or multiphasic product phase of the calcium phosphate bone cement of the invention, easy absorption by the body fluid is achieved versus the opposite for the calcium phosphate bone cement with a single basic phase, such as an apatite (HA), of prior art. Additionally, according to the implant position in clinical trials, those skilled in the art may adjust the ratio of the acid and basic product phase of the invention to improve the osteo-regeneration and biosorption rate. Therefore, the calcium phosphate bone cement of the invention may be applied to vertebra reconstruction and dental restoration and applied as bone replacement material.

The calcium phosphate bone cement of the invention has the following advantages:

(a) The nanocrystallites on the surface of the calcium phosphate with a low Ca/P atomic ratio not only shorten setting time but also prevent the calcium phosphate with a low Ca/P atomic ratio from dispersing in a simulate body fluid.

(b) Due to the biphasic or multiphasic product phase of the calcium phosphate bone cement of the invention, easy absorption by the body fluid is achieved versus the opposite for the calcium phosphate bone cement with a single basic phase, such as an apatite (HA), of prior art.

(c) According to the implant position in clinical trials, those skilled in the art may adjust the ratio of the acid and basic product phase of the invention to improve the osteo-regeneration and biosorption rate.

### EXAMPLE

### Example 1

### (1) Fabrication of a TTCP

The TTCP powder is prepared by reaction of dicalcium pyrophosphate (Ca₂P₂O₇) and calcium carbonate (CaCO₃) using the method suggested by Brown and Epstein (Journal of Research of the National Bureau of Standards—A physical and Chemistry 6 (1965) 69A 12). The reaction is shown as follows:

2CaCO₃+Ca₂P₂O₇→Ca₄P₂O₉+2CO₂

### (2) Fabrication of a DCPA Powder Having Nanocrystallites on the Surface Thereof

5 g of the dicalcium phosphate anhydrous (DCPA, CaHPO₄) is immersed in 40 ml of diluted phosphate aqueous solution (25 mM, pH=1.96). Then, the tetracalcium phosphate (TTCP) is added into the diluted phosphate aqueous solution to form a mixture. The mixture is left to stand at room temperature for 15 minutes to carry out a growing reaction. After 15 minutes, the growing reaction is stopped by washing the mixture using deionized water. Then, the solution is filtered and washed several times to obtain the DCPA powder having nanocrystallites on the surface thereof.

### (3) Fabrication of a Calcium Phosphate Bone Cement

2.07 g of the DCPA (8 μm in diameter) and 5.54 g of TTCP (3 μm in diameter) are mixed in a 100 ml of polyethylene (PE) vessel. The mixture is mechanically mixed in a ball mill filled with aluminum oxide (4 times the weight of the mixture) for 24 hours to obtain the calcium phosphate bone cement.

### Examples 2-11

The procedures of Example 1 are repeated except that the time allotted for growing the nanocrystallites and the amount of DCPA were adjusted as shown in Table 1.

TABLE 1

| | | DCPA addition/TTCP |
|---|---|---|
| | Growing time | addition |
| Example | (minutes) | (g/g) |
| Example 2 | 20 | 2.07/5.54 |
| Example 3 | 20 | 3.11/5.54 |
| Example 4 | 20 | 4.14/5.54 |
| Example 5 | 20 | 5.18/5.54 |
| Example 6 | 20 | 6.21/5.54 |
| Example 7 | 20 | 2.07/5.54 |
| Example 8 | 35 | 3.11/5.54 |
| Example 9 | 35 | 4.11/5.54 |
| Example 10 | 35 | 5.18/5.54 |
| Example 11 | 35 | 6.21/5.54 |

### Example 12

The surface of the calcium phosphate bone cement (CPC) of Example 1 was observed by a TEM (transmission electron microscopy). The bright field images and the dark field images of the TEM show that the nanocrystallites were grown on the surface of the calcium phosphate bone cement.

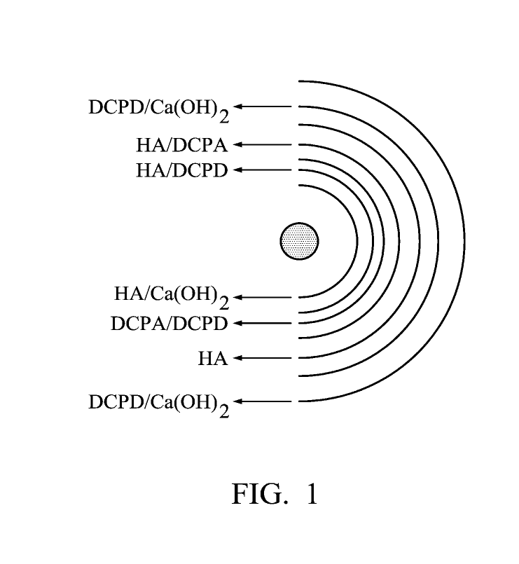

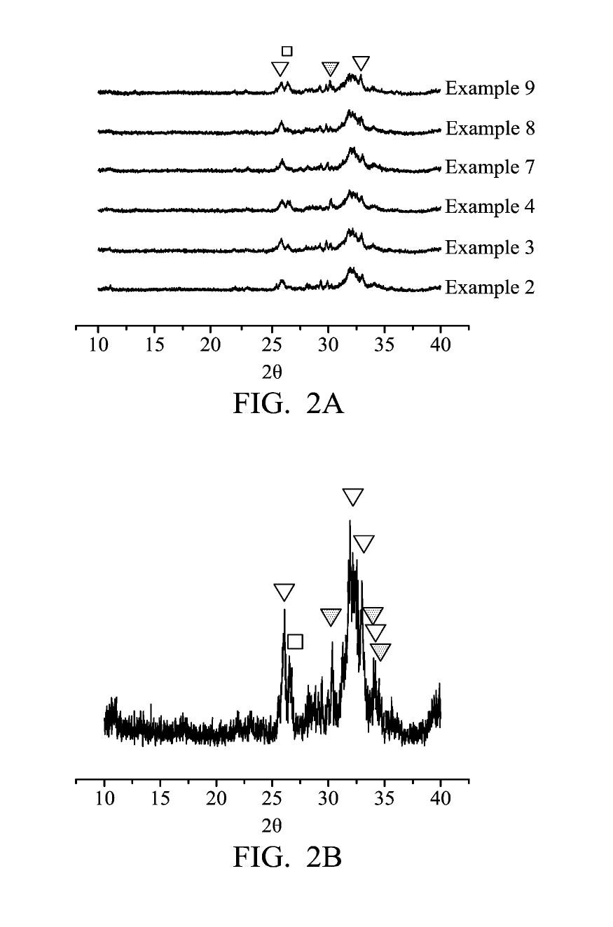

Further, FIG. 1 shows in the selected area diffraction (SAD) of the CPC of Example 1, that the component of the nanocrystallites on the surface are dicalcium phosphate anhydrous (DCPA), dicalcium phosphate dihydrate (DCPD), hydroxyapatite (HA) and Ca(OH)₂. The nanocryatallites have a width of about 1-100 nm and a length of about 10-1000 nm. FIG. 2A to FIG. 2B show the x-ray diffraction images (Rigaku D-max IIIV x-ray diffractometer, Tokyo, Japan) of CPC of Examples 2-4 and 7-9.

FIG. 2A shows the product phases of the CPC of Examples 2-4 and 7-9 after being immersed in a simulate body fluid (such as Hanks' solution) for 24 hours. The product phases are multiphasic product phases comprising dicalcium phosphate anhydrous (DCPA), dicalcium phosphate dihydrate (DCPD), and hydroxyapatite (HA).

FIG. 2B shows a product phase of the CPC of Example 4 after being immersed in a simulate body fluid (such as Hanks' solution) for 32 days. The data shows that after immersing in the simulate body fluid for a period of time, the multiphasic product phase still existed therein. Those skilled in the art may adjust the multiphasic product phase according to the implant position for clinical application.

### Example 13

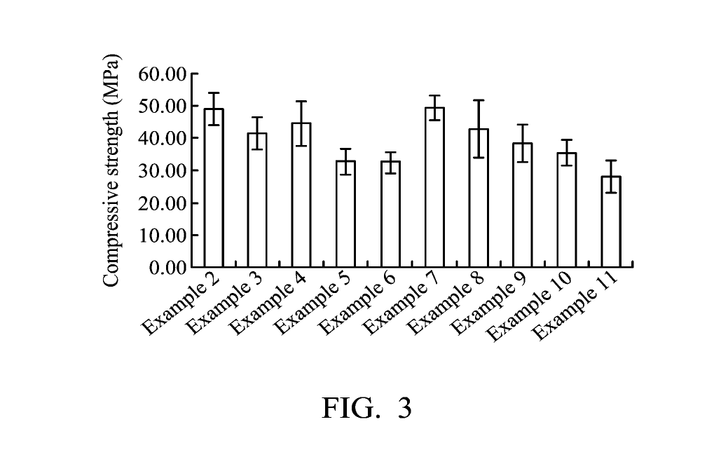

Referring to FIG. 3, according to the ASTM F451-99a standard, the CPC of Examples 2-11 were immersed in a simulate body fluid (such as Hanks' solution) to measure the compressive strengths thereof. The data shows that while the time for growing nanocrystallites of the CPC was about 20-35 minutes, the compressive strength of the CPC was larger than 30 MPa. Therefore, the mechanical strength of the calcium phosphate bone cement was maintained at an acceptable level even after the addition of the calcium phosphate with a low Ca/P atomic ratio larger than that of the prior art.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fabrication method for a calcium phosphate bone cement, comprising:
(a) dissolving a calcium phosphate with a low Ca/P atomic ratio in an acid solution, wherein the Ca/P atomic ratio is less than 1.33;
(b) adding a calcium phosphate compound or providing a calcium ion-containing compound and a phosphate ion-containing compound into the acid solution to obtain a reaction solution;
(c) allowing the reaction solution to stand to grow nanocrystallites on surfaces of the calcium phosphate with a low Ca/P atomic ratio;
(d) filtering and drying the solution of step (c) to obtain a calcium phosphate powder with a low Ca/P atomic ratio having nanocrystallites on the surface; and
(e) mixing the powder of step (d) and a calcium phosphate powder with a high Ca/P atomic ratio.

2. The fabrication method for a calcium phosphate bone cement as claimed in claim 1, wherein the calcium phosphate powder with a high Ca/P atomic ratio comprises octacalcium phosphate (OCP, Ca₈(HPO₄)₂(PO₄)₄.5H₂O), tricalcium phosphate (TCP, Ca₃(PO₄)₂), amorphous calcium phosphate (ACP, Caₓ(PO₄)_{y}.nH₂O), calcium-deficient hydroxyapatite (CDHA, Ca₁₀(HPO₄)ₓ(PO₄)₆₋ₓ(OH)₂₋ₓ, 0<X<1), hydroxyapatite (HA, Ca₁₀(PO₄)₆(OH)₂)), fluorapatite (FA, Ca₅(PO₄)₃F) or tetracalcium phosphate (TTCP, Ca₄(PO₄)₂O).

3. The fabrication method for a calcium phosphate bone cement as claimed in claim 1, wherein the powder of step (d) and the calcium phosphate powder with a high Ca/P atomic ratio are mixed with a ratio of 1/1-3/1.

4. The fabrication method for a calcium phosphate bone cement as claimed in claim 1, wherein the calcium phosphate with a low Ca/P atomic ratio comprises dicalcium phosphate anhydrous (DCPA, CaHPO₄), dicalcium phosphate dihydrate (DCPD, CaHPO₄.2H₂O), monocalcium phosphate (MCPM, Ca(HPO₄)₂.H₂O), monocalcium phosphate anhydrate (MCPA, Ca(HPO₄)₂), calcium sodium phosphates (CaNaPO₄) or calcium potassium phosphate (CaKPO₄).

5. The fabrication method for a calcium phosphate bone cement as claimed in claim 1, wherein the acid solution comprises HNO₃, HCl, H₃PO₄, H₂CO₃, NaH₂PO₄, KH₂PO₄, NH₄H₂PO₄, CH₃COOH, malic acid, lactic acid, citric acid, oxalic acid, malonic acid, succinic acid, glutaric acid, tartaric acid or combinations thereof.

6. The fabrication method for a calcium phosphate bone cement as claimed in claim 1, wherein the calcium phosphate compound in the step (b) comprise octacalcium phosphate (OCP, Ca₈(HPO₄)₂(PO₄)₄.5H₂O), tricalcium phosphate (TCP, Ca₃(PO₄)₂), amorphous calcium phosphate (ACP, Caₓ(PO₄)_{y}.nH₂O), calcium-deficient hydroxyapatite (CDHA, Ca₁₀(HPO₄)ₓ(PO₄)₆₋ₓ(OH)₂₋ₓ, 0<X<1), fluorapatite (FA, Ca₅(PO₄)₃F), hydroxyapatite (HA, Ca₁₀(PO₄)₆(OH)₂), tetracalcium phosphate (TTCP, Ca₄(PO₄)₂O), calcium potassium phosphate (CaKPO₄), calcium sodium phosphates (CaNaPO₄) or combinations thereof.

7. The fabrication method for a calcium phosphate bone cement as claimed in claim 1, wherein the calcium ion-containing compound in the step (b) comprises calcium oxide (CaO), calcium hydroxide (Ca(OH)₂) or calcium carbonate (CaCO₃).

8. The fabrication method for a calcium phosphate bone cement as claimed in claim 7, wherein the phosphate ion-containing compound in the step (b) comprises phosphorus pentoxide (P₂O₅), sodium phosphate (Na₃PO₄), sodium phosphate dibasic, (Na₂HPO₄), sodium dihydrogen phosphate (NaH₂PO₄), phosphoric acid (H₃PO₄), potassium phosphate (K₃PO₄), potassium phosphate dibasic (K₂HPO₄), sodium dihydrogen phosphate (KH₂PO₄), ammonium phosphate ((NH₄)₃PO₄), ammonium phosphate dibasic ((NH₄)₂HPO₄) or ammonium dihydrogen phosphate (NH₄H₂PO₄).

9. The fabrication method for a calcium phosphate bone cement as claimed in claim 1, wherein the calcium phosphate with a low Ca/P atomic ratio is present in a concentration of about 0.01-10 g/ml.

10. The fabrication method for a calcium phosphate bone cement as claimed in claim 1, wherein the calcium phosphate with a low Ca/P atomic ratio in the step (a) has a diameter smaller than about 200 μm.

11. The fabrication method for a calcium phosphate bone cement as claimed in claim 1, wherein the calcium phosphate with a low Ca/P atomic ratio in the step (a) has a diameter larger than that of the calcium phosphate with a high Ca/P atomic ratio.

12. The fabrication method for a calcium phosphate bone cement as claimed in claim 1, wherein the nanocrystallites have a width of about 1-100 nm.

13. The fabrication method for a calcium phosphate bone cement as claimed in claim 1, wherein the nanocrystallites have a length of about 10-1000 nm.

14. The fabrication method for a calcium phosphate bone cement as claimed in claim 1, wherein the nanocrystallites of the step (c) are grown for about 5-60 minutes.

15. The fabrication method for a calcium phosphate bone cement as claimed in claim 1, wherein the calcium phosphate bone cement has a biphasic or multiphasic product phase.

16. The fabrication method for a calcium phosphate bone cement as claimed in claim 15, wherein the biphasic or multiphasic product phase comprises an acid phase and a basic phase.

17. The fabrication method for a calcium phosphate bone cement as claimed in claim 16, wherein the acid phase comprises dicalcium phosphate anhydrous (DCPA, CaHPO₄), dicalcium phosphate dihydrate (DCPD, CaHPO₄.2H₂O), monocalcium phosphate (MCPM, Ca(HPO₄)₂.H₂O), monocalcium phosphate anhydrate (MCPA, Ca(HPO₄)₂), calcium sodium phosphates (CaNaPO₄) or calcium potassium phosphate (CaKPO₄).

18. The fabrication method for a calcium phosphate bone cement as claimed in claim 16, wherein the basic phase comprises octacalcium phosphate (OCP, Ca₈(HPO₄)₂(PO₄)₄.5H₂O), tricalcium phosphate (TCP, Ca₃(PO₄)₂), amorphous calcium phosphate (ACP, Caₓ(PO₄)_{y}.nH₂O), calcium-deficient hydroxyapatite (CDHA, Ca₁₀(HPO₄)ₓ(PO₄)₆₋ₓ(OH)₂₋ₓ, 0<X<1), fluorapatite (FA, Ca₅(PO₄)₃F), hydroxyapatite (HA, Ca₁₀(PO₄)₆(OH)₂) or tetracalcium phosphate (TTCP, Ca₄(PO₄)₂O).

19. The fabrication method for a calcium phosphate bone cement as claimed in claim 15, wherein the multiphasic product phase comprises dicalcium phosphate dihydrate (DCPD, CaHPO₄.2H₂O), dicalcium phosphate anhydrous (DCPA, CaHPO₄) or hydroxyapatite (HA, Ca₁₀(PO₄)₆(OH)₂).

20. A calcium phosphate bone cement precursor, comprising:
a calcium phosphate powder with a low Ca/P atomic ratio having nanocrystallites on the surface thereof, wherein the low Ca/P atomic ratio is less than 1.33; and
a calcium phosphate powder with a high Ca/P atomic ratio, wherein the high Ca/P atomic ratio is larger than 1.33.

21. The calcium phosphate bone cement precursor as claimed in claim 20, wherein the calcium phosphate powder with a low Ca/P atomic ratio comprises dicalcium phosphate anhydrous (DCPA, CaHPO₄), dicalcium phosphate dehydrate (DCPD, CaHPO₄. 2H₂O), monocalcium phosphate (MCPM, Ca(HPO₄)₂.H₂O), monocalcium phosphate anhydrate (MCPA, Ca(HPO₄)₂), calcium sodium phosphates (CaNaPO₄) or calcium potassium phosphate (CaKPO₄).

22. The calcium phosphate bone cement precursor as claimed in claim 20, wherein the calcium phosphate powder with a high Ca/P atomic ratio comprises octacalcium phosphate (OCP, Ca₈(HPO₄)₂(PO₄)₄.5H₂O), tricalcium phosphate (TCP, Ca₃(PO₄)₂), amorphous calcium phosphate (ACP, Caₓ(PO₄)_{y}.nH₂O), calcium-deficient hydroxyapatite (CDHA, Ca₁₀(HPO₄)ₓ(PO₄)₆₋ₓ(OH)₂₋ₓ, 0<X<1), hydroxyapatite (HA, Ca₁₀(PO₄)₆(OH)₂)), fluorapatite (FA, Ca₅(PO₄)₃F) or tetracalcium phosphate (TTCP, Ca₄(PO₄)₂O).

23. The calcium phosphate bone cement precursor as claimed in claim 20, wherein the calcium phosphate powder with a low Ca/P atomic ratio having nanocrystallites on the surface thereof and the calcium phosphate powder with a high Ca/P atomic ratio are mixed with a ratio of 1/1˜3/1.

24. The calcium phosphate bone cement precursor as claimed in claim 20, wherein the nanocrystallites have a width of about 1-100 nm.

25. The calcium phosphate bone cement precursor as claimed in claim 20, wherein the nanocrystallites have a length of about 10-1000 nm.

26. A calcium phosphate bone cement, comprising:
a calcium phosphate powder with a low Ca/P atomic ratio having nanocrystallites on the surface thereof; and
a calcium phosphate powder with a high Ca/P atomic ratio, wherein the calcium phosphate powder with a high Ca/P atomic ratio are mixed with the calcium phosphate powder with a low Ca/P atomic ratio to form the calcium phosphate bone cement, and the calcium phosphate bone cement has a biphasic or multiphasic product phase.

27. The calcium phosphate bone cement as claimed in claim 26, wherein the biphasic or multiphasic product phase comprises an acid phase and a basic phase.

28. The calcium phosphate bone cement as claimed in claim 27, wherein the acid phase comprises dicalcium phosphate anhydrous (DCPA, CaHPO₄), dicalcium phosphate dihydrate (DCPD, CaHPO₄.2H₂O), monocalcium phosphate (MCPM, Ca(HPO₄)₂.H₂O), monocalcium phosphate anhydrate (MCPA, Ca(HPO₄)₂), calcium sodium phosphates (CaNaPO₄) or calcium potassium phosphate (CaKPO₄).

29. The calcium phosphate bone cement as claimed in claim 27, wherein the basic phase comprises octacalcium phosphate (OCP, Ca₈(HPO₄)₂(PO₄)₄.5H₂O), tricalcium phosphate (TCP, Ca₃(PO₄)₂), amorphous calcium phosphate (ACP, Caₓ(PO₄)_{y}.nH₂O), calcium-deficient hydroxyapatite (CDHA, Ca₁₀(HPO₄)ₓ(PO₄)₆₋ₓ(OH)₂₋ₓ, 0<X<1), fluorapatite (FA, Ca₅(PO₄)₃F), hydroxyapatite (HA, Ca₁₀(PO₄)₆(OH)₂) or tetracalcium phosphate (TTCP, Ca₄(PO₄)₂O).

30. The calcium phosphate bone cement as claimed in claim 26, wherein the multiphasic product phase comprises dicalcium phosphate dihydrate (DCPD, CaHPO₄.2H₂O), dicalcium phosphate anhydrous (DCPA, CaHPO₄) or hydroxyapatite (HA, Ca₁₀(PO₄)₆(OH)₂).
